(19) United States
(12) Patent Application Publication
(10) Pub. No.: US 2017/0312656 A1
(43) Pub. Date: Nov. 2, 2017

(54) SEPARATING LIQUID AND GAS

(71) Applicant: HEWLETT-PACKARD INDIGO B.V., Amstelveen (NL)

(72) Inventors: Yaron Yahav, Nes Ziona (IL); Yonni Hartstein, Ramat Gan (IL); Avichay Mor-Yosef, Jerusalem (IL)

(21) Appl. No.: 15/526,694

(22) PCT Filed: Jan. 22, 2015
(86) PCT No.: PCT/EP2015/051233

§ 371 Date: May 12, 2017

(51) Int. Cl. B01D 19/00

(52) U.S. Cl. CPC B01D 19/0042

(57) ABSTRACT

An apparatus for separating liquid and gas comprises a first pipe having a gas outlet at an upper first portion thereof and a liquid outlet at a lower second portion thereof. The apparatus further comprises a second pipe extending at least partly along the first pipe and comprising an inlet for a mix of liquid and gas. A plurality of holes fluidically connects an interior of the second pipe to the interior of the first pipe between the first portion and the second portion of the outer pipe.

### BACKGROUND

In fluid or liquid systems, there are many instances when it is desirable to separate liquid and gas from a mixture of liquid and gas. For example, in liquid systems in which fluid is circulated from a fluid tank through system components and back again to the liquid tank, air may be trapped inside the system. It may be desirable to separate the air from the liquid. It may be desirable to return liquid to the liquid in the fluid tank without generating foam or bubbles in the tank.

### BRIEF DESCRIPTION

Examples will now be described, by way of non-limiting example only, with reference to the accompanying drawings, in which:

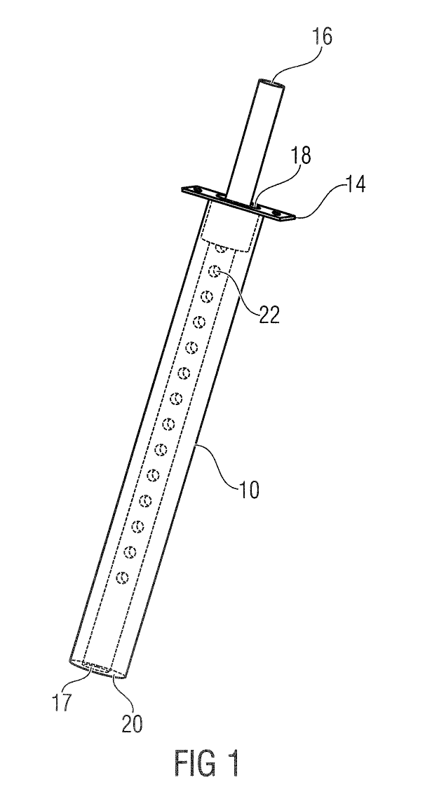

FIG. 1 is a schematic perspective view of an apparatus for separating liquid and gas according to one example;

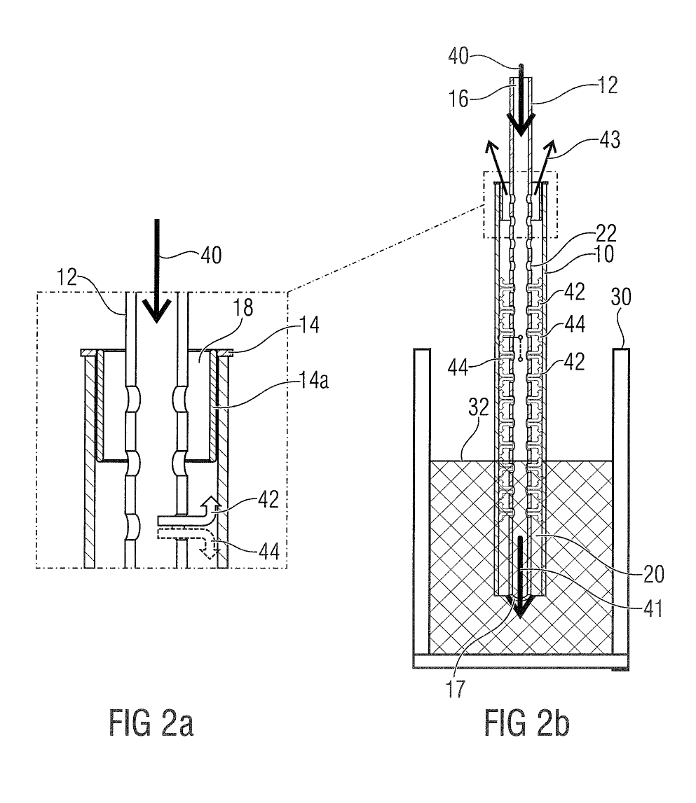

FIGS. 2a and 2b are schematic cross-sectional views of an apparatus for separating liquid and gas according to one example;

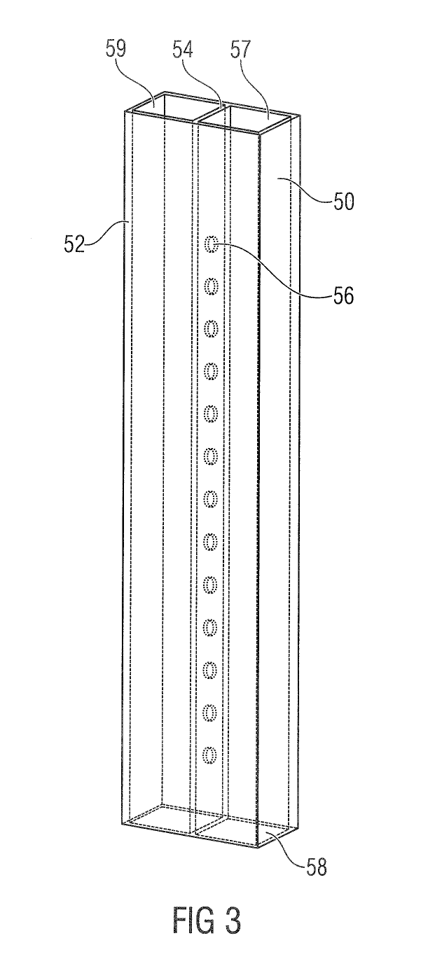

FIG. 3 a schematic perspective view of an apparatus for separating liquid and gas according to another example; and

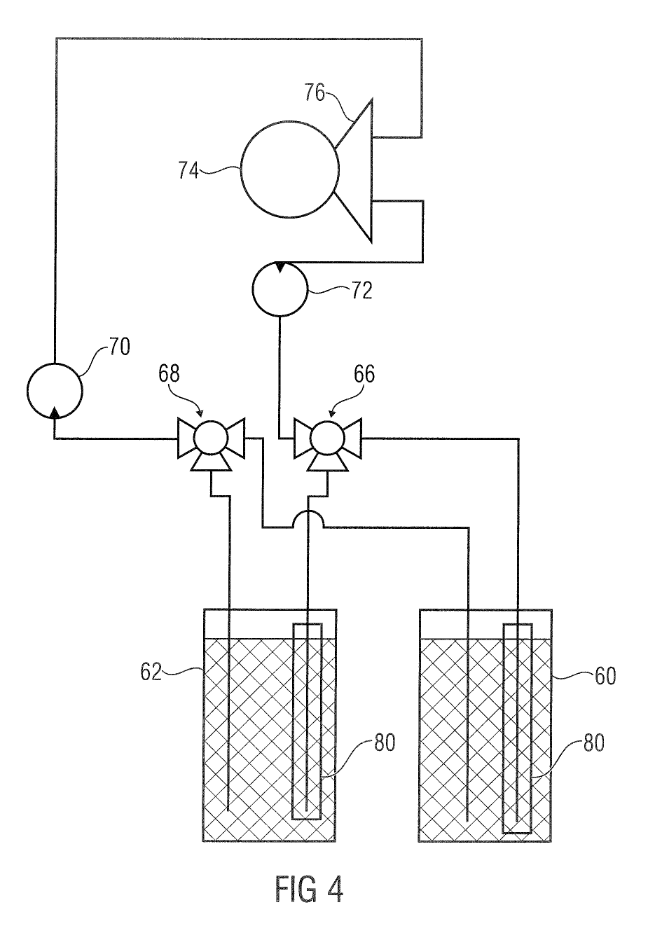

FIG. 4 is a block diagram of a system according to one example.

In the drawings, some elements may be depicted in an at least partially transparent manner in order to show features which would otherwise be obstructed by such elements.

In liquid systems or fluid systems, fluid may be circulated from a fluid tank through system components, such as hoses, pumps, valves, chambers, doctor blades, etc., and back again to the fluid tank. The liquid flow may be open to the atmosphere and air may be trapped inside the system. For example, air may be trapped through vent openings, through vented chambers or between a doctor blade and an anilox drum. Thus, fluid comprising a mix of liquid and gas may be generated in the liquid system. Examples are directed to a system to separate liquid and gas from such a mix of liquid and gas, i.e. from a fluid comprising liquid and gas. Examples may be directed to a printer system. Other examples may be directed to other liquid systems such as beverage systems. Examples are directed to a system to separate liquid and gas from a mix of liquid and gas and to prevent bubbles and/or the generation of foam when the liquid is returned to a liquid tank.

Before describing examples herein it is to be noted that, as used herein, the terms “upper”, “lower”, “below”, “above”, “vertical” and “horizontal” indicate a respective position or direction relative to the gravitational field of the earth.

Examples provide an apparatus comprising a first pipe having a gas outlet at an upper first portion thereof and a liquid outlet at a lower second portion thereof, a second pipe comprising an inlet for a mix of liquid and gas, wherein, in an assembled state, to separate a liquid and a gas, the second pipe extends at least partly along the first pipe, and a plurality of holes fluidically connect an interior of the second pipe to the interior of the first pipe between the first portion and the second portion of the first pipe.

In examples, the first pipe may be an outer pipe and the second pipe may be an inner pipe arranged at least partly within the outer pipe with a space therebetween. The plurality of holes may fluidically connect the interior of the inner pipe to the space between the first portion and the second portion of the outer pipe.

In examples, the first pipe and the second pipe may be arranged side by side, wherein the holes may be formed in a wall separating the interior of the first pipe from the interior of the second pipe.

In such an apparatus, if a fluid flow of a mix of liquid and gas is effected within the second pipe, liquid and gas of the mix of liquid and gas may move through the plurality of holes, liquid may descend in the first pipe and may escape through the liquid outlet of the first pipe and gas may ascend in the first pipe and escape through the gas outlet of the first pipe.

In examples, in the assembled state, the first and second pipe are positioned stationary relative to each other. In examples, mounts may be provided to attach the first and second pipe to each other. A common holder or separate holders may be provided to hold the first and second pipe in the stationary positional relationship.

In examples, the apparatus comprises a liquid tank and a lower end of the second pipe is open and is fluidically coupled to the interior of the liquid tank. The lower end of the second pipe may be arranged below a liquid level in the liquid tank. Thus, generation of bubbles and/or foam in the liquid in the liquid tank may be prevented or at least reduced.

In examples, the lower second portion of the first pipe may be arranged within the liquid tank so that the liquid outlet is fluidically coupled to the interior of the liquid tank. In examples, the gas outlet may be fluidically coupled to the atmosphere.

An example of an apparatus is shown in FIG. 1. The apparatus comprises an outer pipe 10 and an inner pipe 12. The inner pipe 12 is arranged within the outer pipe 10 with a space therebetween. In other words, an outer wall of the inner pipe 12 is spaced from an inner wall of the outer pipe 10. The outer pipe 10 and the inner pipe 12 may be arranged coaxially with respect to each other. The space between the inner pipe 12 and the outer pipe 10 may completely encompass the inner pipe 12. In other examples, the space may be interrupted in the circumferential direction.

A holder or adaptor 14 may be provided to attach the outer pipe 10 to an external device, such as a holding plate. The inner pipe 12 comprises an inlet 16 for a mix of liquid and gas. The inlet 16 may be arranged at an upper end of the inner pipe 12. The inner pipe comprises a lower end 17. The lower end may be open, i.e. may permit a fluid flow from the interior of the inner pipe 12 to the outside, or may be closed, i.e. may not permit a fluid flow from the interior of the inner pipe 12 to the outside.

The outer pipe comprises a gas outlet 18 at an upper first portion thereof and a liquid outlet 20 at a lower second portion thereof. The gas outlet 18 may be formed at the upper end of the outer pipe 10 and the liquid outlet 20 may be formed at the lower end of the outer pipe 10. The gas outlet 18 of the outer pipe 10 may be formed by the open upper end of the outer pipe 12 and the liquid outlet 20 of the outer pipe 10 may be formed by the lower open end of the outer pipe 10.

A plurality of holes 22 fluidically connecting the interior of the inner pipe 12 to the space between the inner pipe 12 and the outer pipe 10 are provided in the inner pipe 12.

In an example, holes may be arranged at a plurality of different axial positions of the inner pipe along the portion of the inner pipe 12, which is arranged within the outer pipe 10. For example, holes may be arranged at fifteen different axial positions. At each axial position, a plurality of holes may be formed, such as two holes at opposite sides of the inner pipe 12. In examples, holes having different dimensions, such as different diameters, may be provided at different positions, such as different axial positions.

The holder 14 is to fix the outer pipe 10 to an external device while permitting escape of gas through the gas outlet 18 in the outer pipe 10. For example, holder 14 may comprise a sleeve 14a having open upper and lower ends and arranged within and mounted to the outer pipe 10. For example, holder 14 may function to position the outer pipe 10 relative to a liquid tank. Additional elements (not shown) may be provided to position the inner pipe relative to the outer pipe. For example, the inner pipe may be mounted to the same external device as the outer pipe or to a different external device. The inner pipe (second pipe) may be mounted stationary relative to the outer pipe (first pipe)

In the example shown in FIG. 1, the outer pipe 10 is formed by a large diameter tube having a circular cross-section and the inner pipe 12 is formed by a small diameter tube having a circular cross-section. In other examples, the outer pipe and the inner pipe may have different cross-sections, such as elliptical, rectangular or square cross-sections. The gas outlet 18 represents a release aperture in an upper area of the outer pipe 10 and may be arranged in a different plane when compared to the inlet 16 of the inner pipe 12 and not overlapping with same. The lower ends of the inner pipe 12 and the outer pipe 10 may be arranged in the same plane.

In operation, a fluid flow of a mix of liquid and gas may be effected within the inner pipe 12 which is arranged within the outer pipe 10 to cause liquid and gas of the mix of liquid and gas to move through the plurality of holes, to cause liquid to descend in the space and to escape through the liquid outlet of the outer pipe, and to cause gas of the mix to ascend in the space and to escape through the gas outlet of the outer pipe. Thus, liquid and gas contained in the fluid flow may be separated from each other.

An example of an apparatus comprising a liquid tank 30 is shown in FIGS. 2a and 2b, wherein FIG. 2b is an enlarged view of a portion of FIG. 2a.

As shown in FIG. 2a, the lower portion of the apparatus comprising the inner pipe 12 and the outer pipe 10 may be immersed into the liquid tank 30. In the example shown, the lower end 17 of the inner pipe 12 is open. The lower end of the apparatus is immersed into the liquid tank 30 such that the open lower end 17 of the inner pipe 12 is arranged below a liquid level 32 of a liquid arranged within the liquid tank 30. In addition, the lower portion of the outer pipe 10, in which the liquid outlet 20 is formed, may be immersed into the liquid tank 30 such that the liquid outlet 20 is below the liquid level 32 in the liquid tank 30.

In operation, a fluid flow 40 of a mix of liquid and gas is effected within the inner pipe 12.

In the example shown, the fluid flow 40 is inside the inner pipe 12 downstream. The gas may be air. The fluid flows down the inner pipe 12 and through the open end 17 into the liquid tank 30. The liquid arranged in the liquid tank 30 provides a resistance for the flow of gas in the mix of liquid and gas through the open end 17. The lower end of the inner pipe 12 may be arranged at such a position within the liquid tank that the resistance which the liquid in the liquid tank provides is sufficient to prevent the gas from passing the open end 17. Thus, the gas will not enter the liquid tank through the open end 17, but will be driven through the openings 22 into the space between the inner pipe 12 and the outer pipe 10. In addition, some liquid of the mix will be driven through the holes 22. In other words, the holes 22 in the inner pipe 12 release air and liquid of the mix from the inner pipe 12 to the space between the inner pipe 12 and the outer pipe 10. The air ascends in the space between the inner pipe 12 and the outer pipe 10 and is released from the volume between the inner pipe 12 and the outer pipe 10 through the gas outlet 18 to the atmosphere, see arrows 42 and 43 in FIGS. 2a and 2b. The liquid descends in the space between the inner pipe 12 and the outer pipe 10 and flows down to the liquid tank 30, see arrows 44 in FIGS. 2a and 2b.

The combined flow cross-section of the inner pipe and the outer pipe 10 is larger than the flow cross-section of the inner pipe 12. Thus, the liquid moves from a small area pipe to a large area pipe. The flow rate may remain constant and therefore the velocity of flow may be reduced according to Q=V*A, wherein Q is the volumetric flow rate, V is the velocity of flow and A is the flow cross-section. Thus, the liquid, such as the liquid on the inner surface of the outer pipe 10, is flowing with reduced (slow) velocity to the liquid tank 30 and therefore additional air or bubble creation can be avoided or at least reduced. Accordingly, examples may be referred to as representing a bubbles preventing pillar. It is to be noted that the liquid driven through the openings 22 in the inner pipe 12 may hit the inner surface of the outer pipe 10 or may descend in the space between the inner pipe 10 and the outer pipe 12 without hitting the inner surface of the outer pipe 10. The liquid descending in the space between the inner pipe 12 and the outer pipe 10 may be released to the liquid tank 30 through the liquid outlet 20 and may combine with the liquid in the liquid tank 30.

Generally, the outer pipe and the inner pipe may be arranged such that gas may ascend within the space between the inner pipe and the outer pipe and liquid may descend in the space between the inner pipe and the outer pipe. Accordingly, the first portion of the outer pipe is an upper portion of the outer pipe and the second portion of the outer pipe is a lower portion of the outer pipe. In examples, the axis of the outer pipe and the inner pipe comprise an angle of less than 20° relative to the vertical direction. In examples, as shown in FIGS. 2a and 2b, the axis of the outer pipe and the inner pipe are arranged vertically.

Generally, the number and the arrangement of the holes 22 formed in the inner pipe 12 may vary. In examples, the plurality of holes comprise holes arranged at different axial positions along the length of the inner pipe. In examples, the plurality of holes comprise holes arranged at at least ten different axial positions along the length of the inner pipe. In examples, the plurality of holes comprise holes arranged at the same axial position along the length of the inner pipe.

In examples, the inlet for the mix of liquid and gas is arranged at an upper end of the inner pipe. In alternative examples, the inlet for the mix of liquid and gas may be arranged at a lower end of the inner pipe. In examples, a pressurizer may be provided to effect the fluid flow of the mix of liquid and gas within the inner pipe. In examples, the fluid flow of the mix of liquid and gas within the inner pipe may be effected by gravitational force.

FIG. 3 shows another example of an apparatus for separating liquid and gas, in which a first pipe 50 extends along a second pipe 52. In the example shown, the first pipe 50 and the second pipe 52 are arranged side by side and an interior of the first pipe 50 is separated form an interior of the second pipe 52 by a wall 54. Holes 56 are formed in the wall 54 and fluidically couple the interior of the first pipe 50 to the interior of the second pipe 52. The upper end of the first pipe 50 may represent a gas outlet 57 and the lower end of the first pipe 50 may represent a liquid outlet 58. The upper end of the second pipe 52 may represent an inlet 59 for a mix of liquid and gas. The lower end of the second pipe 52 may be open or closed. The first and second pipe may have a cross-section different from the cross-section shown in FIG. 3 and the holes 56 may have an arrangement different from the arrangement shown in FIG. 3.

In operation, a fluid flow of a mix of liquid and gas is effected in the second pipe 52. The lower end of the second pipe 52 may be closed or may be arranged within a liquid tank similar to the example described above with respect to FIGS. 2a and 2b. Thus, an operation which is analog to the operation described above with respect to FIGS. 2a and 2b may be achieved, wherein liquid and air is driven from the second pipe 52 through the openings 56 into the first pipe 50, gas ascends in the first pipe 50 and escapes through the gas outlet 57 and liquid descends in the first pipe 50 and escapes through the liquid outlet 58. If the lower end of the second pipe 52 is open, liquid may escape through the lower end of the second pipe 52, while air may be prevented from passing through the lower end of second pipe 52 by a resistance which the liquid in a liquid tank, in which the lower end of the second pipe may be immersed, provides.

Examples provide a system comprising an apparatus for separating liquid and gas as described herein, a liquid tank, and a fluid path fluidically connecting the liquid tank to the inlet of the inner pipe.

One example of a system is shown in FIG. 4. The system comprises a first fluid tank 60 and a second fluid tank 62. The first liquid tank 60 may contain a cleaning solution and the second liquid tank 62 may contain a primer. The system may comprise a first valve 66, a second valve 68, a supply pump 70, a return pump 72, an anilox 74 and a chamber 76. The anilox 74 may be arranged within chamber 76.

The respective components are connected by fluid lines as schematically shown in FIG. 4. First and second valves 66 and 68 are switchable to create a closed fluid circuit including either the first liquid tank 60 or the second liquid tank 62. If the first liquid tank 60 is switched into the circuit, liquid from the first liquid tank 60 is pumped to the chamber 76 by means of supply pump 70 and returned to the liquid tank 60 by means of the return pump 72. If the second liquid tank is switched into the circuit, liquid from the second liquid tank 62 is pumped to the chamber 76 by means of supply pump 70 and returned to the liquid tank 62 by means of return pump 72. The components and the fluid lines represent a fluid flow path. The fluid flow path between the inlet and the outlet of the respective liquid tank may be open to atmosphere and air may be trapped inside the system, such as in the chamber 76 or between the anilox drum 74 and a doctor blade. Generally, the return pump 66 may be configured to provide a pressure which is slightly higher than a pressure provided by the supply pump 70. This may result in air being drawn into the fluid flow path. Thus, a fluid containing a mix of liquid and gas, such as air, may result. When such fluid is entering the liquid tank again through an inlet tube, i.e. the fluid line connecting the first valve 66 to the respective liquid tank, the combination of trapped air and the liquid may cause bubbles inside the tank. When using liquids such as primer materials, foam may be created inside the tank and may eventually overflow outside the tank. In addition, the foam may disturb a level sensor reading and may prevent the usage of level sensing techniques.

Thus, in examples, one or both liquid tanks may be provided with an apparatus as described herein for separating liquid and gas, as schematically indicated in FIG. 4 by blocks 80. In such examples, the fluid line connecting the first valve 66 to the respective liquid tank will be connected to the inlet for a mix of liquid and gas, such as the inlet 16 shown in FIG. 2a.

Thus, in examples, creation of bubbles in a liquid tank may be prevented or at least reduced. Moreover, creation of foam in a liquid tank may be prevented or at least reduced.

Accordingly, adverse effects on the operation of a level sensor in a liquid tank may be prevented or at least reduced. Thus, the robustness of measurements may be increased and more accurate measurements may be achieved. In addition, different level sensors may be used in the liquid tank. In addition, the liquid tank may be filled to a higher level and half the tank does not need to remain empty. In addition, anti-foam additives do not need to be added to a primer in the liquid tank.

In examples, a turbulent flow in a fluid line fluidically connected to the inlet of the inner pipe may be transformed into a laminar flow. Accordingly, examples provide a low cost and robust solution for preventing or reducing generation of bubbles or foam in liquid systems.

All of the features disclosed in this specification (including accompanying claims, abstract and drawings), and/or all of the steps of any method or process so disclosed, may be combined in any combination, except combinations where at least some features and/or steps are mutually exclusive.

Each feature disclosed in this specification (including any accompanying claims, abstract and drawing) may be replaced by alternative features serving the same, equivalent or similar purpose, unless expressly stated otherwise. Thus, unless expressly stated otherwise, each feature disclosed is one example only of a generic series of equivalent or similar features.

1. An apparatus comprising:
a first pipe having a gas outlet at an upper first portion thereof and a liquid outlet at a lower second portion thereof;
a second pipe comprising an inlet for a mix of liquid and gas,
wherein, in an assembled state, to separate a liquid and a gas the second pipe extends at least partly along the first pipe; and a plurality of holes fluidically connect an interior of the second pipe to the interior of the first pipe between the first portion and the second portion of the first pipe.

2. The apparatus of claim 1, wherein the first pipe is an outer pipe and wherein the second pipe is an inner pipe arranged at least partly within the outer pipe with a space therebetween, wherein the plurality of holes fluidically connect the interior of the inner pipe to the space between the first portion and the second portion of the outer pipe.

3. The apparatus of claim 1, wherein axes of the first pipe and the second pipe comprise an angle of less than 20° relative to the vertical direction or wherein the axes of the first pipe and the second pipe are arranged vertically.

4. The apparatus of one of claim 1, wherein the plurality of holes comprise at least one of holes arranged at different axial positions along the length of the second pipe and holes arranged at the same axial position along the length of the second pipe.

5. The apparatus of claim 4, wherein the plurality of holes comprise holes at at least 10 different axial positions along the length of the second pipe.

6. The apparatus of one of claim 1, wherein the inlet for a mix of liquid and gas is arranged at an upper end of the second pipe.

7. The apparatus of one of claim 1, wherein the first pipe and the second pipe are arranged coaxially.

8. The apparatus of one of claim 1, comprising a liquid tank, wherein a lower end of the second pipe is open and is fluidically coupled to the interior of the liquid tank.

9. The apparatus of claim 8, wherein the lower second portion of the first pipe is arranged within the liquid tank and the liquid outlet is fluidically coupled to the interior of the liquid tank.

10. The apparatus of one of claim 1, comprising a liquid tank, wherein the lower second portion of the first pipe is arranged within the liquid tank and the liquid outlet is fluidically coupled to the interior of the liquid tank.

11. A system comprising:
an apparatus according to one of claim 8;
the liquid tank; and
a fluid path fluidically connecting the liquid tank to the inlet of the second pipe.

12. A method comprising:
effecting a fluid flow of a mix of liquid and gas within a second pipe, wherein the second pipe is extending at least partly along a first pipe, to cause liquid and gas of the mix of liquid and gas to move through a plurality of holes connecting an interior of the second pipe to the interior of the first pipe, to cause liquid of the mix to descend in the first pipe and to escape through a liquid outlet of the first pipe, and to cause gas of the mix to ascend in the first pipe and to escape through a gas outlet of the first pipe to separate the liquid and the gas.

13. The method of claim 12, wherein the first pipe is an outer pipe and wherein the second pipe is an inner pipe arranged at least partly within the outer pipe with a space therebetween, wherein the plurality of holes fluidically connect the interior of the inner pipe to the space between the first portion and the second portion of the outer pipe.

14. The method of claim 13, comprising immersing at least one of the first pipe and the second pipe into a liquid tank to arrange at least one of an open lower end of the second pipe and the liquid outlet of the first pipe below a liquid level in the liquid tank.

15. The method of claim 14, comprising driving liquid from the liquid tank through a fluid path to the inlet of the second pipe.
